(19) United States
(12) Patent Application Publication
(10) Pub. No.: US 2007/0203939 A1
(43) Pub. Date: Aug. 30, 2007

(54) Alert Flags for Data Cleaning and Data Analysis

(76) Inventor: James Michael McArdle, Austin, TX (US)

Correspondence Address: Robert H. Frantz, P.O. Box 23324, Oklahoma City, OK, 73123, US

(21) Appl. No.: 11/747,374

(22) Filed: May 11, 2007

Related U.S. Application Data
(62) Division of application No. 10/631,172, filed on Jul. 31, 2003.

(51) Int. Cl. G06F 17/30

(52) U.S. Cl. 707/102

(57) ABSTRACT

A data structure and methods for generating and using the data structure which contains cleaning attribute flags for each field of a database record which has been modified by a data cleaning operation. The flags may are used to determine if a pattern, cluster or trend identified during data mining of the cleaned data is likely to have been influenced by the data cleaning process, especially to a degree which leads to identification of false trends, patterns, or clusters.

### BACKGROUND OF THE INVENTION

1. Field of the Invention

This invention relates to methods for error detection and quality control for data cleaning, data mining and data warehouse management.

2. Background of the Invention

This is a divisional application claiming benefit to the filing date of U.S. application Ser. No. 10/631,172, docket number AUS920030382US2, filed on Jul. 31, 2003, by James Michael McArdle.

Data mining is the process of interpreting or extracting useful information, patterns or “knowledge”, from large sets of data. The initial data is often “raw” or unprocessed, and is most often contained in one or more databases. Data is “mined” in order to determine useful knowledge such as product performance characteristics, customer behavior, consumer demographics, etc. Data mining techniques assist in detecting patterns, trends and clusters within data sets. For the purposes of this disclosure, we will refer to these identified characteristics of data sets as data set features. FIG. 1 illustrates a generalized process of data mining from beginning to end. The data is collected often from multiple “populations” (2a, 2b, 2c), such as a set of users of a particular website, a set of responders to a survey, or a set of data reporting systems (e.g. satellite broadcast decoder boxes which report viewing habits, point-of-sale terminals, credit card transaction processing systems, web sites which report “click through” statistics, etc.). This information is often in different formats from one population to another due to differences in the sources, compliance of the sampled individuals with the collection effort (e.g. partial completion of survey forms, misleading completion of some fields of a survey form, etc.), and differences in the data collection (3a, 3b, 3c) methods and systems. As such, the initial “raw” data from these sources may be incomplete, may include errors, and may include false information. For example, one user of a web site may enter an incorrect mailing ZIP code by error, while another may enter a false ZIP code in order to avoid being tracked by the system, and another may not enter a ZIP code at all if the system will allow a non-response to an item.

Data collection systems may include a wide variety of technologies including, but not limited to, servlets running on web servers which track user “clicks” and responses, online sales systems, survey data entry systems, and transaction analysis systems. Each of the data collection systems may also “miss” collection of some items due to transmission errors, queue overflows, timeouts, etc., and may incorrectly substitute data for “default” values when no value is received for a particular item. Additionally, most data collection systems use one of several “standardized” or proprietary formats to store the collected data into one or more databases (4a, 4b, 4c). For example, three possible consumer purchase record formats for point-of-sale (“POS”) transactions are shown in Table 1. Each of these sets of “fields” or “data items” are often organized and stored as a database record.

TABLE 1
Three Example POS Record Formats

Format A:
<total_amount> <date> <buyer_ZIP_code> <time> <data>
Format B:
<date> <buyer_ZIP_code> <time> <data> <total_amount>
Format C:
<total_amount> <date> <frequen_buyer_ID> <time> <data>

In these three examples, record formats A and B contain the same information, albeit in different orders. Format C contains 4 fields of the same information in record formats A and B, but substitutes a frequent buyer identifier instead of a buyer's ZIP code. This buyer identifier, for example, may be correlated to the buyer's ZIP code through membership records, if desired.

As can be imagined, there are an infinite number of possible data items, order of those items, and encoding of those items (e.g. total sales amounts in whole dollars or dollars with 2 assumed cent values, time as local time or GMT, buyer ID as string or BCD, etc.).

Additionally, the storage format of these records into databases (4a, 4b, 4c) can vary greatly depending on the database technology itself, such as IBM DB2, Oracle, etc.

Ultimately, however, it is often desired by businesses and enterprises to combine data from as many sources as possible in order to generate the largest “data warehouse” possible, for further examination and analysis to determine sales trends, consumer behavior and preferences, etc. An initial step to this end is to obtain multiple data sets from these databases (4a, 4b, 4c), to convert the records to a common format, merge the data sets, and “clean” the data (5). Conversion and formatting rules (6) are often employed to facilitate the first portion of this step, such as a rule to format all monetary values into integers wherein the two least significant digits represent cents, and wherein all text characters (e.g. dollar signs, commas, points, etc.) are eliminated. Additionally, formatting rules (6) may provide for limiting (e.g. all values are less than $99,999.99), format enforcement (e.g. all ZIP codes are 5 digits, all telephone numbers are 10 digits), rounding, etc. During the conversion and formatting processes, more errors, inaccuracies and assumptions are inserted into the data.

The data is often “merged” into a single database, which may result in duplicate or contradictory records in the unified data set. For example, two records for the same customer (from different data sources) may end up in the merged data set which indicate two different income brackets for the customer, or two different home addresses for the same customer. Or, duplicate data for a customer may be merged into the unified data set which represents unnecessary storage requirements, and may cause incorrect statistical weighting. For example, if three databases are merged, and two of the databases have a high degree of overlap between the customers represented therein, the final merged data set may be incorrectly skewed towards the characteristics of the overlapping customers.

So, to eliminate or reduce these types of errors, “data cleaning” is performed. Data cleaning generally involves some or all of the previously described steps (e.g. formatting, limiting, defaulting, converting, merging, etc.), but may also include some more intelligent data value analysis and adjustment. Each of these cleaning operations is governed by cleaning rules (7).

For example, if data being warehoused includes a household income bracket, and a particular record for a particular customer contains a null or blank value (e.g. the customer didn't type in a value for his or her income in a survey form), certain demographic information which associates average household income with ZIP code may be used to insert an assumed income value based on the ZIP code the customer provided.

Certain other data cleaning techniques attempt to correct what appears to be incorrect information, which may have been acquired through error or user falsification. For example, another responder to a survey may have entered a false household income of $1M, which is known to be hundreds of times larger than a regional average income of $60,000 based upon the responder's ZIP code or address. So, it may be assumed that the user does not actually have an income of $1M per year, and the average value may be used to replace the responder's income.

As such, data cleaning operations, when used to describe the aforementioned manipulations of “raw” data, necessarily insert assumptions, errors and inaccuracies in some of the records of the data.

Following the cleaning processes (5), data mining (8) and analysis (11) are performed. In this phase, the data examined to identify patterns and establish relationships. Some common data mining results include:
(a) “associations”—patterns where one event is connected to another event;
(b) “sequences or paths”—patterns or trends where one event leads to another later event;
(c) “classifications”—new patterns which may result in a change in the way the data is organized;
(d) “clusters”—groups of facts which share common characteristics; and
(e) “forecasts”—patterns in the data that are predictive of future data.

Data mining provides a useful tool for an analyst to predict future data by analyzing current trends that are not obvious within a huge amount of data. The process of data mining can be quite tedious, as many databases have grown to contain more than a Terabyte of data. The processes and tools used to mine data are most useful when combined with a real business/information analyst. A skilled analyst can use data mining techniques and tools to obtain useful information from the heaps of data in the database.

Using data mining programs can produce results and reveal trends, but unless the pieces of information under review are carefully selected, the results may be meaningless or misleading. Examples of useful trends include, customer shopping habits, when a customer shops, what he buys, and how much of a product. If data mining can produce a trend based on the information, then a company could target the particular customer by placing items he buys on a typical basis near each other or in an easily accessible location at a certain time during the day.

Though data mining tools can locate patterns and trends, these tools are unable to interpret any value for the data. A company must use the located trends to determine the value of the information. Statistical “outliers” must be explained in patterns. These outliers can potentially corrupt a set of data if they are ignored. The algorithms used to compare data must be carefully selected to produce the expected results. Irrelevant values may cause inaccurate or incorrect information.

Certain mining rules (9) and analysis techniques (10) are configured and employed, under the control of the analyst. For example, when mining one set of data which an analyst suspects has a high degree of inaccurate data for customer ZIP codes, the analyst may place a very low weight or score on the ZIP code data to keep clusters from being identified incorrectly based upon ZIP code. Or, the analyst may configure a rule to completely ignore ZIP code data.

Eventually, one or more reports (12) are produced which identify these associations, trends, and forecasts. The reports (12) are reviewed (13), and if errors are apparent or suspected, adjustments (14) to the rules and technique parameters may be made, and the cleaning, mining and analysis processes may be repeated (15).

However, as a result of the cleaning operations, certain trends, clusters, or associations may appear to be true even to a skilled analyst. For example, consider data being analyzed which has been collected from cash registers at a home improvement retail establishment. Also assume that the data includes time of day of the sale, day of the sale, amount of the sale, a list of the items purchased and their prices, and the ZIP code of the buyer for each transaction. All of this information can be automatically collected from the Universal Product Code (“UPC”) data (e.g. “barcode” data) from the point-of-sale system, except that the ZIP code data must be manually entered by the POS operator. However, some cashiers may not like asking for ZIP codes as they feel they are invading the customers' privacy, and they may simply enter their own ZIP code to get past the required entry step in the transaction process. This would create a “cluster” showing that many of the customers were from the same neighborhood as the cashier. This type of human-inserted error or inaccuracy is difficult to diagnose or spot due to its point of insertion—at the very point of collection.

In another example, the cleaning processes (5) insert errors as previously mention by setting missing data to averages or default values, truncating and rounding values, re-formatting data, etc. This may also lead to false mining results, such as clusters around default values which were inserted for missing data. This kind of error trend is also difficult to manually detect, but may be detected if the original data is available and can be compared to the “cleaned” data, as shown in FIG. 2. The “raw” databases (4a, 4b, 4c) may be compared (22) to the “cleaned” database (21) to generate reports (23) regarding trends and statistics of the cleaning results. For example, if 40% of the ZIP code data in the raw databases was missing and replaced with default values, any clusters around ZIP code may be suspect.

However, two issues arise with such a process (2) of comparing raw data to the cleaned data. First, the raw data must be available after cleaning has been performed, which is often not the case. Often, the raw data has not been maintained due to its location and size. Second, the comparison (22) process must also implement certain assumptions and rules regarding format conversions, numeric and text forms, etc., because the “raw” data is often in various formats, as previously described.

So, in summary, during the course of doing the virtuous cycle of data mining, the data to be mined must first be cleaned, during which records are removed or adjusted records to fit within certain attribute constraints. Adjusted records have one or more incomplete or out of range fields which are adjusted to either a default value or to a statistically nominal value. Data mining algorithms, however, are sensitive to statistical trends in data and may falsely arrive at wrong conclusions. As there exists no efficient or practical system or method to automatically detect patterns in the cleaning “adjustments”, human analysts must make their best “judgments” as to the accuracy and reliability of the mining results. This may lead to costly errors made by corporations based on the mining results.

Therefore, there is a need in the art for a system and method which allows for efficient and accurate detection of mining results which may be heavily skewed or caused by actions of the data cleaning process, without need for maintaining the volumes of raw data.

### SUMMARY OF THE INVENTION

The present invention provides a system and method whereby data cleaning information is carried along with the cleaned data as an associated attribute, or in a parallel table, for use in characterizing data mining results after a data mining run.

During the data cleaning process, each “row” or record in the cleaned data set will have been assigned to a cluster. The cleaning attribute associated with each cleaned record indicates which fields in the record have been modified, and which are in original state, preferrably in a bit-mapped or “bit flag” register format.

At least four embodiments of our “data cleaning flags” are available within the scope of the present invention, including but not limited to:
(a) maintaining the data cleaning flags as a part of the cleaned data records;
(b) maintaining the data cleaning flags in a parallel table containing only references to cleaned data records;
(c) maintaining a parallel table of data cleaning flags which includes a data record key, a cleaned field ID, and possibly the “raw” or pre-cleaned data value;
(d) maintaining a cleaned field list (f1=y, f5=y, f7=y) in any of the formats described in (a), (b), or (c).

While methods (a) and (b) lend themselves to statistics collection which may be factored into a data mining analysis, methods (c) and (d) provide added tracking data in case an analyst wants to investigate trends further.

A subsequent data mining clustering process is employed to find clusters, and to provides a list of attributes that most influenced individuals becoming members of the cluster. The attribute list is preferrably in “entropy” order, meaning that customers in the cluster have a high percentage of this same value, whereas customers outside the cluster have a low percentage of this attribute. Well-known entropy ordering methods use a mathematical ratio such as percentage in a cluster to percentage outside of a cluster (e.g. [% in cluster]/[% outside of cluster]).

Statistical work may be done using the data cleaning flags for rows or records which belong to a given cluster to determine if that cluster may be a false cluster based upon cleaning influences. For example, if a cluster around ZIP code is detected, then the cleaning attributes for all of the records in that cluster may be examined. If it turns out that a high percentage of ZIP code data was modified during cleaning, the cluster may be identified as highly suspect, and its importance in decision making can be properly weighed. If, however, a cluster is based upon attributes which do not have a high degree of having been cleaned, the cluster may be considered to be more likely a reflection of characteristics of the data set, and thereby given more weight in decision making.

### BRIEF DESCRIPTION OF THE DRAWINGS

Preferred embodiments of the present invention will now be described, by way of example only, with reference to the accompanying drawings in which:

FIG. 1 illustrates the general overall process of collecting and mining data in an enterprise.

FIG. 2 shows an optional process of comparing “raw” or original data to “cleaned” data to determine if cleaning actions inserted any false patterns or trends into the data.

FIG. 3 depicts a generalized computing platform architecture, such as a personal computer, enterprise server computer, personal digital assistant, web-enabled wireless telephone, or other processor-based device.

FIG. 4 shows a generalized organization of software and firmware associated with the generalized architecture of FIG. 3.

FIGS. 5a and 5b show two possible embodiments of the cleaning attributes with association to the cleaned data.

FIG. 6 shows the generalized logical process of our invention for creating or generating cleaning attributes.

FIG. 7 provides a generalized view of the logical process of our invention to determine if mining analysis results are likely skewed or influenced by the cleaning.

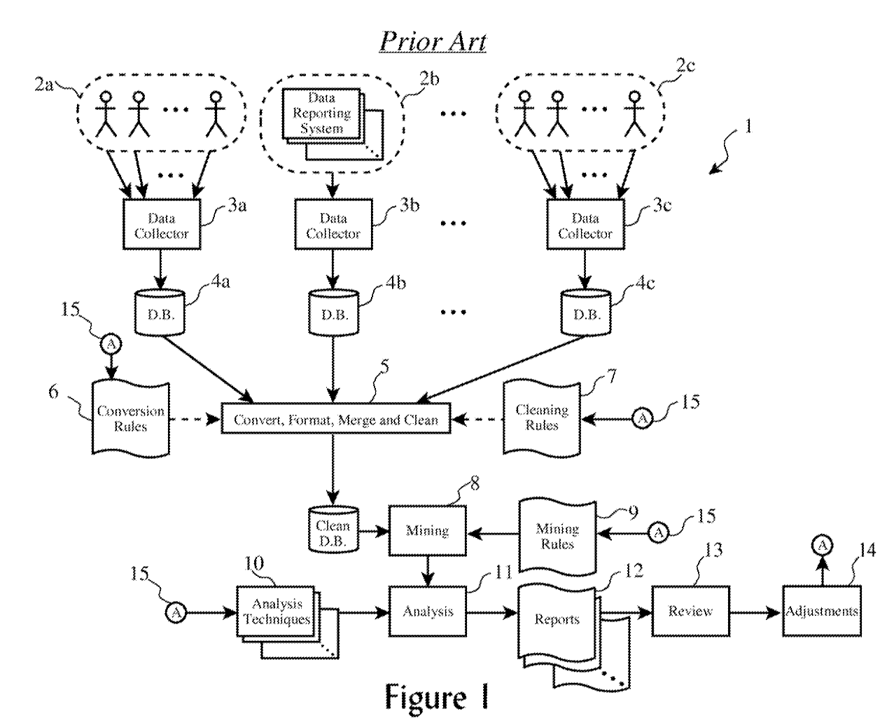

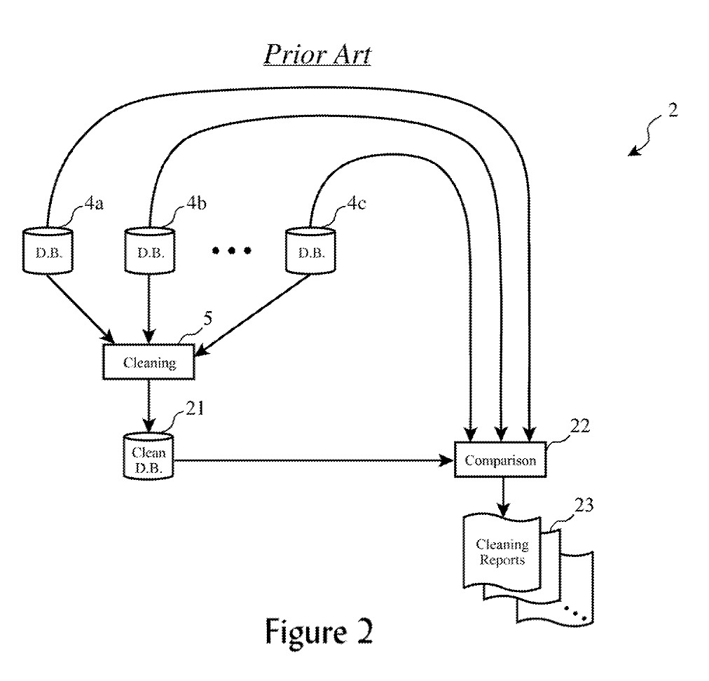

### DESCRIPTION OF THE INVENTION

The present invention is preferrably realized as a software program, module or method which may be called or instantiated by other programs such as existing data mining software suites. It will be readily recognized, however, that alternate embodiments such as inline code for data mining suite, or even realization as hard logic, may be made without departing from the scope of the present invention.

We first present a general discussion of computing platforms suitable for realization of the invention according to the preferred embodiment. These computing platforms include enterprise servers and personal computers (“PC”), as well as portable computing platforms, such as personal digital assistants (“PDA”), web-enabled wireless telephones, and other types of personal information management (“PIM”) devices. As the computing power and memory capacity of the “lower end” and portable computing platforms continues to increase and develop, it is likely that they will be able to execute the software jobs which are currently handled by the “higher end” platforms such as PC's and servers.

Therefore, it is useful to review a generalized architecture of a computing platform which may span the range of implementation, from a high-end web or enterprise server platform, to a personal computer, to a portable PDA or web-enabled wireless phone.

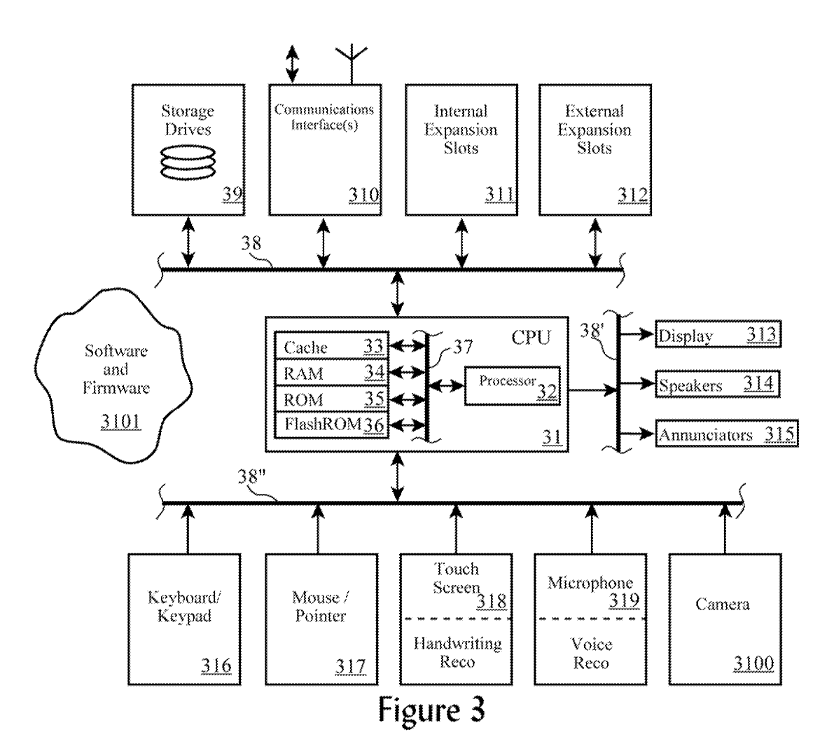

Turning to FIG. 3, a generalized architecture is presented including a central processing unit (31) (“CPU”), which is typically comprised of a microprocessor (32) associated with random access memory (“RAM”) (34) and read-only memory (“ROM”) (35). Often, the CPU (31) is also provided with cache memory (33) and programmable FlashROM (36). The interface (37) between the microprocessor (32) and the various types of CPU memory is often referred to as a “local bus”, but also may be a more generic or industry standard bus.

Many computing platforms are also provided with one or more storage drives (39), such as a hard-disk drives (“HDD”), floppy disk drives, compact disc drives (CD, CD-R, CD-RW, DVD, DVD-R, etc.), and proprietary disk and tape drives (e.g., Tomega Zip™ and Jaz™, Addonics SuperDisk™, etc.). Additionally, some storage drives may be accessible over a computer network.

Many computing platforms are provided with one or more communication interfaces (310), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IrDA) interface, too.

Computing platforms are often equipped with one or more internal expansion slots (311), such as Industry Standard Architecture (ISA), Enhanced Industry Standard Architecture (EISA), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots (312) allowing the user the ability to easily install and remove hardware expansion devices, such as PCMCIA cards, SmartMedia cards, and various proprietary modules such as removable hard drives, CD drives, and floppy drives.

Often, the storage drives (39), communication interfaces (310), internal expansion slots (311) and external expansion slots (312) are interconnected with the CPU (31) via a standard or industry open bus architecture (38), such as ISA, EISA, or PCI. In many cases, the bus (38) may be of a proprietary design.

A computing platform is usually provided with one or more user input devices, such as a keyboard or a keypad (316), and mouse or pointer device (317), and/or a touch-screen display (318). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (318) is usually provided, often with handwriting recognition capabilities.

Additionally, a microphone (319), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (3100), such as a still digital camera or full motion video digital camera.

One or more user output devices, such as a display (313), are also provided with most computing platforms. The display (313) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (314) and/or annunciators (315) are often associated with computing platforms, too. The speakers (314) may be used to reproduce audio and music, such as the speaker of a wireless telephone or the speakers of a personal computer. Annunciators (315) may take the form of simple beep emitters or buzzers, commonly found on certain devices such as PDAs and PIMs.

These user input and output devices may be directly interconnected (38′, 38″) to the CPU (31) via a proprietary bus structure and/or interfaces, or they may be interconnected through one or more industry open buses such as ISA, EISA, PCI, etc.

The computing platform is also provided with one or more software and firmware (3101) programs to implement the desired functionality of the computing platforms.

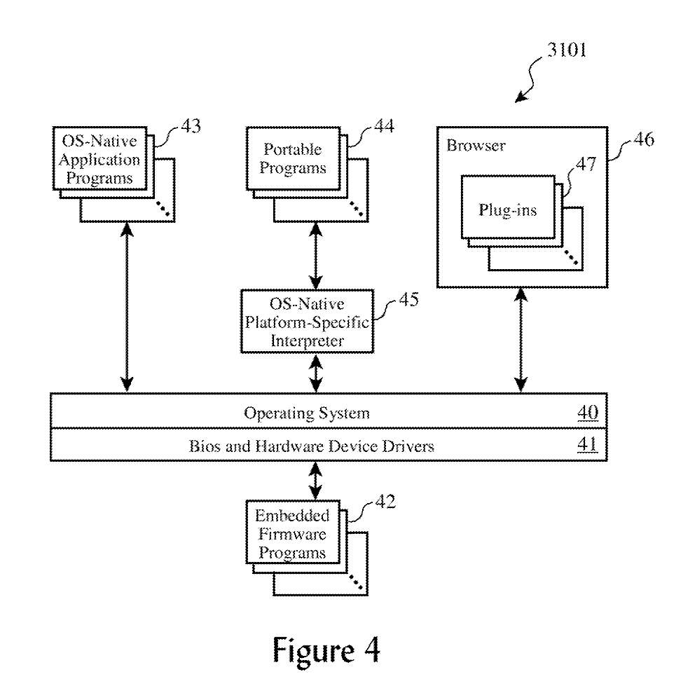

Turning to now FIG. 4, more detail is given of a generalized organization of software and firmware (3101) on this range of computing platforms. One or more operating system (“OS”) native application programs (43) may be provided on the computing platform, such as word processors, spreadsheets, contact management utilities, address book, calendar, email client, presentation, financial and bookkeeping programs.

Additionally, one or more “portable” or device-independent programs (44) may be provided, which must be interpreted by an OS-native platform-specific interpreter (45), such as Java™ scripts and programs.

Often, computing platforms are also provided with a form of web browser or microbrowser (46), which may also include one or more extensions to the browser such as browser plug-ins (47).

The computing device is often provided with an operating system (20), such as Microsoft Windows™, UNIX, IBM OS/2™, LINUX, MAC OS™ or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (21) are often provided to allow the operating system (20) and programs to interface to and control the specific hardware functions provided with the computing platform.

Additionally, one or more embedded firmware programs (22) are commonly provided with many computing platforms, which are executed by onboard or “embedded” microprocessors as part of the peripheral device, such as a micro controller or a hard drive, a communication processor, network interface card, or sound or graphics card.

As such, FIGS. 3 and 4 describe in a general sense the various hardware components, software and firmware programs of a wide variety of computing platforms, including but not limited to enterprise servers, personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

We now turn our attention to description of the method of the invention and it's associated components. It is preferrably realized as a program module in conjunction with the IBM's Business Intelligence Application Architecture using IBM's Intelligent Miner application. These products are optimized for executing on IBM's iSeries servers and AS/400 servers, using IBM's DB2-based Relational Database Management System (“RDBMS”). Many documents, references and guides regarding these well-known products are available from IBM and third parties. Other suitable processing platforms and databases may be used to realize the present invention, as well.

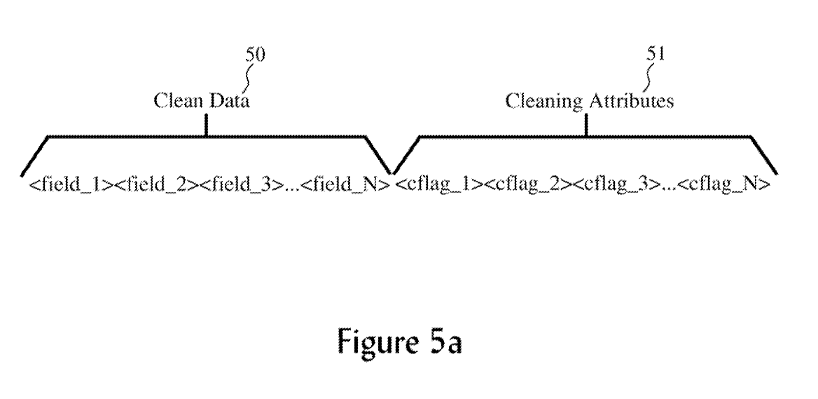

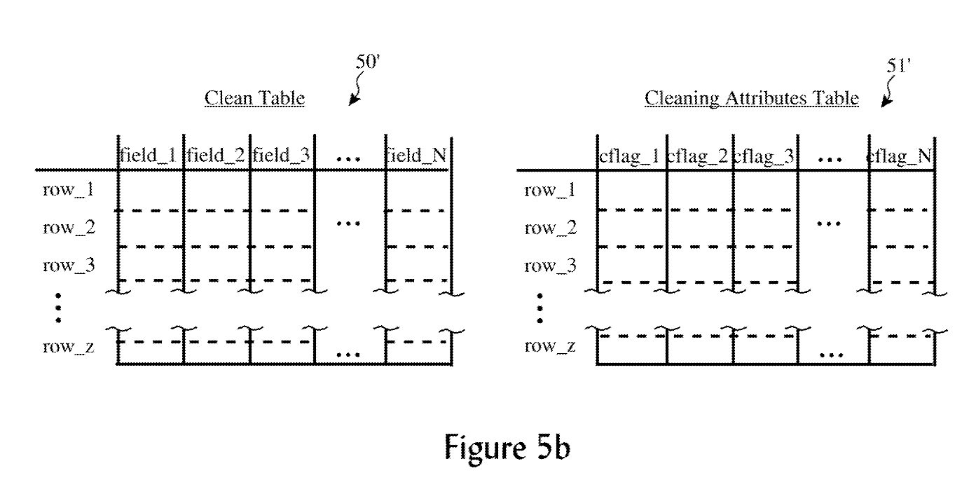

Turning to FIGS. 5a and 5b, two realizations of the association of cleaned data and our cleaning attributes are shown. In FIG. 5a, each record of cleaned data (50) is modified to include one or more cleaning flags (51) as the cleaning attributes for each field in the record. The cleaning flags in this attribute are shown as being appended to the end of the record, but may be alternately prepended to the beginning of the record, or may be distributed throughout the record. For example, a row of cleaned data having field values A, B, C, D, . . . Z (in that order), may be appended to include the cleaning flag attributes as such:
A, B, C, D, . . . Z, <cflag_A>, <cflag_B>, <cflag_C> . . . <cflag_D>

In FIG. 5b, the cleaning attributes (51′) are maintained as a separate table of flags which are aligned with the records or “rows” of the cleaned data table (50′), wherein each row cleaning attribute flags in the cleaning attributes table (51′) corresponds to a row of clean data in the clean data table (50′). This implementation does not require modification of the cleaned data records (as required by the format of FIG. 5a), but requires maintenance of two separate tables or databases which must be kept in alignment. To minimize the alignment maintenance burden for the separate cleaning attributes table, the cleaning attributes table may include a field in each row which indicates which record of clean data it represents, thereby allowing pseudo-random ordering of the cleaning attributes table, and allowing cleaning attributes which contain no positive cleaning flags (e.g. no fields indicated as modified) to be eliminated, such as a record format of:
<clean_row_#> <cflag_{—}1> <cflag_{—}2> <cflag_{—}3> . . . <cflag_N>

wherein the field <clean_row_#> indicates the row within the clean data table (50′) with a particular cleaning flag record is associated. For example, a cleaning flag record having the following values:
219, 0, 0, 1, 0, 0 1 . . . <CR>

would indicate that it is associated with row or record number 219 in the clean data table. As such, an ordered or non-ordered set of cleaning flags may be grouped into a table, maintaining the association with their corresponding cleaned data records, such as:
001, 0, 1, 1, 0, 0 . . . 1<CR>
002, 0, 0, 1, 0, 0 . . . 1<CR>
003, 1, 0, 0, 0, 0 . . . 1<CR>
219, 0, 0, 1, 0, 0 . . . 1<CR>
N, 0, 0, 0, 0, 0 . . . 0<CR>

In one optional embodiment, rows corresponding to clean data records for which no data was modified may be eliminated from the cleaning attributes table such that the cleaning attributes table only contains flags for those data records which have been modified in some manner.

According to our preferred embodiment, the cleaning flags <cflag_i> are Boolean flags having a value True or False (e.g. zero or 1), with an assumption such as “True” indicates a field has been modified in some manner, and “False” indicates a field has not been modified during cleaning, or vice versa. This simplistic data format allows determinations to be made as to whether data mining results are heavily influenced by modified fields or not, while keeping the appended cleaning attributes or separate cleaning attributes table as small as possible for minimal storage impact.

In an alternate embodiment, however, the cleaning flags may assume non-Boolean formats to provide a greater degree of indication of the kind of modification that was made to a field value, such as zero for being unmodified, “1” for being set to a default value due to missing data, “2” for being set to a maximum value, “3” for being set to a minimum value, “4” for being set to an average value for being an invalid value originally, etc. This would allow for more sophisticated analysis of the impact of the cleaning operations on the data mining results, but also increases the storage requirements of the cleaning attributes themselves.

The data structures of FIGS. 5a and 5b may be implemented in standard database formats such as DB2, standard file formats such as comma separated variables (“CSV”) or delimited text, or in meta-language such as eXtensible Markup Language (“XML”). For example, the 219, 0, 0, 1 , 0, 0 . . . 1<CR> record previously disclosed can be disclosed in markup language such as:

<row>
<field_1> A </field_1>
<field_2> B </field_2>
...
<field_N> Z </field_N>
<cflag_1> 0 </cflag_1>
<cflag_2> 0 </cflag_2>
<cflag_3> 1 </cflag_3>
...
<cflag_N> 1 </cflag_N>
</row>

Our preferred embodiment, however, is to append the cleaning attributes to each record in the cleaned data database as shown in FIG. 5a, each cleaning attribute flag being a single bit Boolean indicator. This provides the basic indication and detectability of data mining results being influenced by modified data, with minimal maintenance and storage impact.

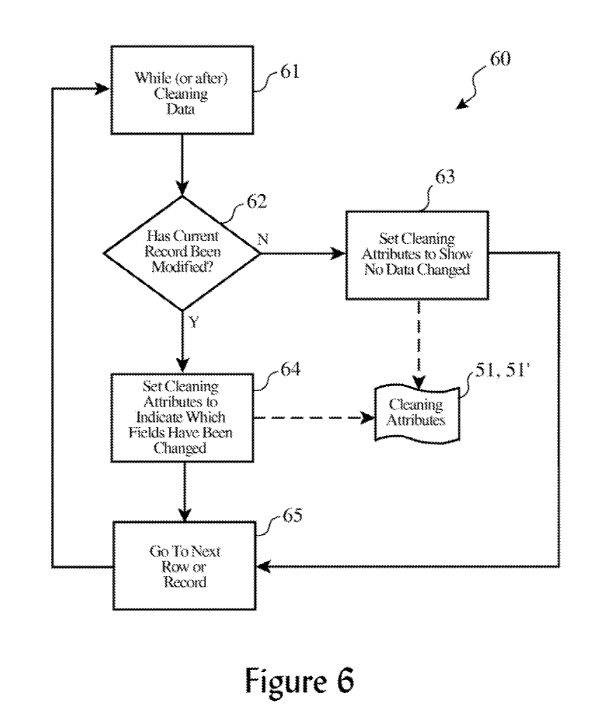

Turning now to FIG. 6, the logical process (60) for creating the cleaning attributes of our invention is shown. During cleaning of raw data (61), if a record has been modified (62), then cleaning attributes (51, 51′) are appropriately set (64) to reflect which fields in that record or row have been changed. If no fields in that record have been modified, then the cleaning attributes (51, 51′) are set (63) to reflect the fact that all of the fields are unadjusted and unmodified. Then, while the next row or record (65) is being cleaned, the same attribute generation steps (62, 63, 64) are performed.

According to our preferred embodiment, the cleaning attributes are simply 1-bit Boolean flags appended to the data records or maintained in a separate table as previously described. Variations on this embodiment include, but are not limited to:
(a) performing the cleaning attribute generation after cleaning of the entire raw data set has been completed, but while the original raw data is available for comparison to the cleaned data;
(b) setting attribute flags of greater precision or descriptive value for modified fields as previously described; and
(c) writing or storing the cleaning attributes after all of the attributes have been generated for all of the cleaned data.

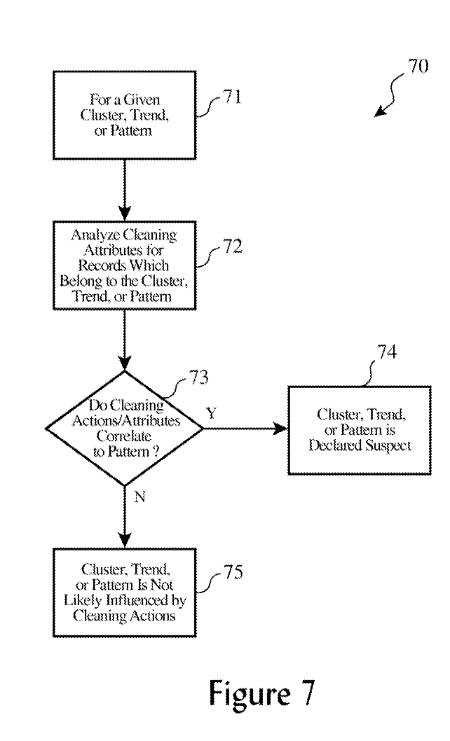

Turning to FIG. 7, a generalized view of the logical process (70) of our invention to determine if mining analysis is skewed or influenced by the cleaning actions is shown. For a given identified cluster, trend, or pattern (71) found in the cleaned data by the data mining process, the cleaning attributes of the records which belong to the cluster, trend or pattern are analyzed to determine if there is a high degree of correlation between the pattern factors and the cleaned fields in the records.

For example, if a trend is identified which shows that a high number of customers from a specific ZIP code shop at a store during a specific time frame, then an analysis will be performed to determine if a high number of ZIP code fields or time fields in the records belonging to this class were modified during cleaning. If the percentage of modified relevant fields exceeds a pre-determined threshold, perhaps 5% in a particular case, then it can be determined that the cleaning actions have unduly influenced or skewed the data mining analysis for this cluster, pattern or trend. Say, for this example, that a particular cashier happens to work the shift for the time frame identified in the trend, that this particular cashier always enters “00000” for a ZIP code instead of asking the customer for their ZIP code, and that the data cleaning techniques are configured to replace “00000” with the ZIP code of the store. As a result, there would appear to be a trend of a high number of customers from the ZIP code of the store shopping during this cashier's shift, which is actually a trend created in the data by the cleaning actions, which will be detected by our post-mining analysis process (70).

While a number of embodiments and variations have been disclosed herein, it will be readily recognized by those skilled in the art that they do not represent the full extent of the present invention, and that variations, subsets and substitutions from these embodiment examples may be made without departing from the spirit and scope of the present invention. Therefore, the scope of the present invention should be determined by the following claims.

1. A data structure in a computer readable medium which enables a computer system to determine the impact and influence of data cleaning operations on the results of data mining analysis comprising:
one or more data records, each record having a plurality of data fields;
a set of cleaning attributes for each data field in each data record indicating which fields have been modified by a data cleaning operation; and
a means operable by said computer system for associating said cleaning attributes with said data fields.

2. The data structure in a computer medium as set forth in claim 1 wherein said cleaning attributes comprise Boolean flags.

3. The data structure in a computer medium as set forth in claim 1 wherein said data records comprise rows in a cleaned data table, wherein said set of cleaning attributes comprise subsets in a cleaning attributes table, and wherein said means for associating said cleaning attributes with said data fields comprises a row index.

4. The data structure in a computer medium as set forth in claim 1 wherein said data records comprise records in a database, wherein said set of cleaning attributes comprise subsets in a cleaning attributes contained in said records, and wherein said means for associating said cleaning attributes with said data fields comprises a means for appending, said cleaning attributes to each record.

5. The data structure in a computer medium as set forth in claim 1 wherein said data records comprise records in a database, wherein said set of cleaning attributes comprise subsets in a cleaning attributes contained in said records, and wherein said means for associating said cleaning attributes with said data fields comprises a means for prepending said cleaning attributes to each record.

6. The data structure in a computer medium as set forth in claim 1 wherein said data records comprise records in a database, wherein said set of cleaning attributes comprise subsets in a cleaning attributes contained in said records, and wherein said means for associating said cleaning attributes with said data fields comprises a means for distributing said cleaning attributes in each record.

7. The data structure in a computer medium as set forth in claim 1 further comprising a data feature identified by a data mining computer process, wherein said data feature comprises a subset of said data records.

8. The data structure in a computer medium as set forth in claim 7 further comprising a declaration value set by a process for determining a degree of correlation of said data feature to modified fields of said data records, wherein said declaration value has at least a first value indicating a suspect nature of said data feature.

9. The data structure in a computer medium as set forth in claim 7 wherein said data feature comprises a cluster.

10. The data structure in a computer medium as set forth in claim 9 further comprising a declaration value set by a process for determining a degree of correlation of said cluster to modified fields of said data records, wherein said declaration value has at least a first value indicating a suspect nature of said data feature.

11. The data structure in a computer medium as set forth in claim 7 wherein said data feature comprises a trend.

12. The data structure in a computer medium as set forth in claim 11 further comprising a declaration value set by a process for determining a degree of correlation of said trend to modified fields of said data records, wherein said declaration value has at least a first value indicating a suspect nature of said data feature.

13. The data structure in a computer medium as set forth in claim 7 wherein said data feature comprises a pattern.

14. The data structure in a computer medium as set forth in claim 13 further comprising a declaration value set by a process for determining a degree of correlation of said pattern to modified fields of said data records, wherein said declaration value has at least a first value indicating a suspect nature of said data feature.
